(19) United States
(12) Patent Application Publication
(10) Pub. No.: US 2020/0368829 A1
(43) Pub. Date: Nov. 26, 2020

(54) CUTTING INSERT AND CUTTING TOOL EQUIPPED THEREWITH

(71) Applicant: KORLOY INC., Seoul (KR)

(72) Inventors: Sung Guen SHIN, Cheongju-si (KR); Byung Hoon MIN, Cheongju-si (KR); Hyo San KIM, Cheongju-si (KR); Young Heum KIM, Cheongju-si (KR)

(73) Assignee: KORLOY INC., Seoul (KR)

(21) Appl. No.: 16/858,258

(22) Filed: Apr. 24, 2020

(30) Foreign Application Priority Data
May 21, 2019 (KR) 10-2019-0059178

(51) Int. Cl. B23C 3/30; B23C 5/20

(52) U.S. Cl. CPC B23C 3/30; B23C 5/20

(57) ABSTRACT

A cutting insert for groove machining is provided, which includes a front cutting edge, a chip breaker groove extending from a rear direction of the front cutting edge in a lengthwise direction of the cutting insert, land portions formed on both sides of the chip breaker groove, and inclined surfaces in continuity with the land portions and extending from the land portions to a rear direction of the cutting insert, in which a distance in a transverse direction between left and right walls of the chip breaker groove gradually increases from an entrance of the chip breaker groove toward a boundary between the land portions and the inclined surfaces, and then gradually decreases upon passing the boundary, and the cutting insert is symmetrical about a longitudinal center line thereof.

### CROSS-REFERENCE TO RELATED APPLICATIONS

This application claims priority from Korean Patent Application No. 10-2019-0059178, filed on May 21, 2019 in the Korean Intellectual Property Office, the disclosure of which is incorporated herein by reference in its entirety.

### BACKGROUND

### Technical Field

The present disclosure relates to a cutting insert for groove machining, and a cutting tool having the same mounted thereon.

### Description of the Related Art

Generally, a cutting insert is fastened to a cutting tool mounted on a machine tool and is used for cutting a workpiece such as a machine part and so on that is made of iron, non-ferrous metal, non-metal material, and so on.

Such a cutting insert includes an upper surface, a lower surface oriented in the opposite direction, a side surface connecting the upper surface and the lower surface to each other, and a cutting edge for cutting the workpiece.

Meanwhile, compared to general turning machining, for groove machining, the space for discharging the chips generated during the machining is considerably insufficient. Therefore, without a reduction of the chip width by the chip breaker or a proper adjustment of the chip curl radius, chip blockage can occur, resulting in breakage of the cutting insert, and also abnormal chip generation can occur, resulting in scratches on the machined surface.

FIG. 13 shows a cutting insert 1 for groove machining disclosed in U.S. Pat. No. 10,118,228 B2 issued on Nov. 6, 2018 (PTL 1), the entire content of which is incorporated herein by reference. For reference, FIG. 13 corresponds to FIG. 1 of PTL 1, and for convenience of description, reference numerals used in PTL 1 are used as they are without modification, and the reference numerals do not necessarily refer to the same components even if they overlap with the reference numerals used in the following description of the present disclosure.

In the cutting insert 1 described above, as the chips generated at the leading cutting edge 2 hit the four shoulder portions 10b and 10d in the rear direction, the chips are deformed in shape and reduced in the chip width.

However, the cutting insert 1 has a problem in that the chip width cannot be effectively reduced because the chips are deformed upon hitting the four shoulder potions 10b and 10d positioned in the rear direction of the insert where the principal force is hardly applied during cutting.

### SUMMARY

The present disclosure has been made to solve the problems described above, and an object of the present disclosure is to provide a cutting insert which is capable of effectively reducing a width of the chips generated during cutting process, and inducing stable chip curling, thus enabling smooth discharge of the chips from the inside of the processed groove to the outside without causing damages to the machined surface.

In order to achieve the objectives mentioned above, a cutting insert for groove machining is provided, which may include a front cutting edge, a chip breaker groove extending from a rear direction of the front cutting edge in a lengthwise direction of the cutting insert, land portions formed on both sides of the chip breaker groove, and inclined surfaces in continuity with the land portions and extending from the land portions to a rear direction of the cutting insert, in which a distance in a transverse direction between left and right walls of the chip breaker groove may gradually increase from an entrance of the chip breaker groove toward a boundary between the land portions and the inclined surfaces, and then gradually decrease upon passing the boundary, and the cutting insert may be symmetrical about a longitudinal center line thereof.

In addition, the left wall may include two-step surfaces in continuity with each other at the boundary, in which a first surface of the two-step surfaces located in a front direction of the boundary may have a smaller slope than a slope of a second surface located in a rear direction of the boundary.

In addition, a protrusion may be formed in a rear direction of the inclined surfaces and higher than the inclined surfaces.

In addition, a protrusion groove may be formed in the chip breaker groove and the protrusion, in which the protrusion groove may be symmetric about the lengthwise center line, may be in continuity with the chip breaker groove without passing through the protrusion, and may have a greater depth than the chip breaker groove.

In addition, when the cutting insert is fastened to a cutting tool, the land portions and the inclined surfaces may form positive angles with a virtual horizontal line parallel to a lower edge of the cutting tool.

In addition, an angle formed by the land portions may be greater than an angle formed by the inclined surfaces.

In addition, the cutting insert may include a groove or a protrusion formed on an upper surface, a lower surface, and a rear surface to be engaged with a corresponding protrusion or groove formed on the cutting tool for fastening.

The cutting insert according to the embodiment of the present disclosure having the configuration described above has the following effects.

In the cutting insert according to the present disclosure, because the transverse distance between the left and right walls of the chip breaker groove, that is, the width is narrower in the front direction of the boundary than in the rear direction of the boundary, during cutting of the workpiece, when the workpiece chips generated from the front cutting edge are discharged to the rear direction of the cutting insert, the generated chips are first compressed between the left and right walls located in the front direction of the boundary, and then compressed secondly between the left and right walls located in the rear direction of the boundary, and accordingly, there is an effect that chips are smaller than when processed by the related cutting insert.

In addition, as the chip width is reduced, scratches on the cutting surface can be reduced, and the chips can be smoothly discharged from the chip break groove.

In addition, because the land portions and the inclined surfaces form the positive angles in two-stages, the chips passed the land portions can be curled once again so that the chip radius is reduced and the chips are lifted upwards. For this reason, there is an effect that the chips are effectively discharged to the outside of the workpiece even in the narrow groove, and also the unnecessary friction of the chips in the chip breaker groove is prevented.

In addition, according to the cutting insert of the present disclosure, grooves or protrusions are formed on the upper surface, the lower surface, and the rear surface to be engaged with corresponding protrusions or grooves formed on the tool holder (e.g., cutting tool), thereby minimizing the occurrence of vibration and movement during machining.

Meanwhile, it goes without saying that the present disclosure includes other effects, although not explicitly stated, that can be expected from the configuration described above.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a cutting insert according to an embodiment of the present disclosure;

FIG. 2 is a plan view of the cutting insert of FIG. 1;

FIG. 3 is a cross-sectional view taken along the D-D and E-E directions of FIG. 1;

FIG. 4 is a side view of the cutting insert of FIG. 1;

FIG. 5A is a partially enlarged view of the encircled portion A of FIG. 4, and FIG. 5B is a schematic view showing a chip passed a land portion being curled once again;

FIG. 6A is a front view showing the cutting insert of FIG. 1, and FIG. 6B is a sectional view taken along the G-G direction;

FIG. 7 is a view showing the cutting insert of FIG. 1 being mounted in a cutting tool;

FIG. 8 is a conceptual view of the principal force being applied when the cutting insert of FIG. 1 is cutting a workpiece;

FIG. 9A is a photograph showing the chip width by a related cutting insert, and FIG. 9B is a photograph showing the chip width by the cutting insert according to the present disclosure, respectively;

FIGS. 10A and 10B show photographs showing result of processing chips with the related cutting insert and the cutting insert according to the present disclosure, in which FIG. 10A corresponds to the result by the related cutting insert, and FIG. 10B corresponds to the result by the cutting insert of the present disclosure, respectively;

FIG. 11 is a view showing V-shaped grooves formed on an upper surface, a lower surface and a rear surface of the cutting insert of FIG. 1;

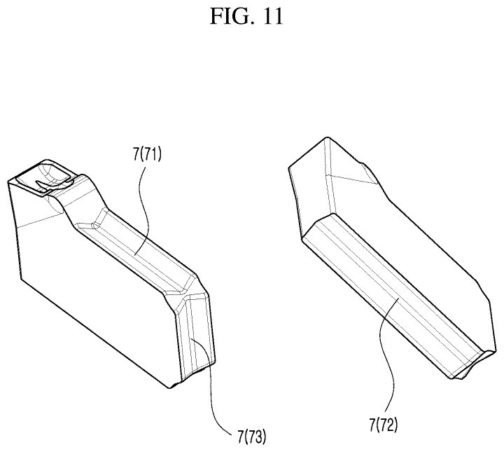

FIG. 12 is a view showing a V-shaped protrusion formed in the tool holder to correspond to the V-shaped grooves of the cutting insert of FIG. 11; and

FIG. 13 is a view showing the conventional cutting insert.

### DETAILED DESCRIPTION

Hereinafter, preferred embodiments of the present disclosure will be described in detail with reference to the accompanying drawings, that will be readily apparent to those skilled in the art to which the present disclosure pertains. However, the description proposed herein is just a preferable example for the purpose of illustrations only, not intended to limit the scope of the disclosure, so it should be understood that other equivalents and modifications could be made thereto without departing from the scope of the disclosure.

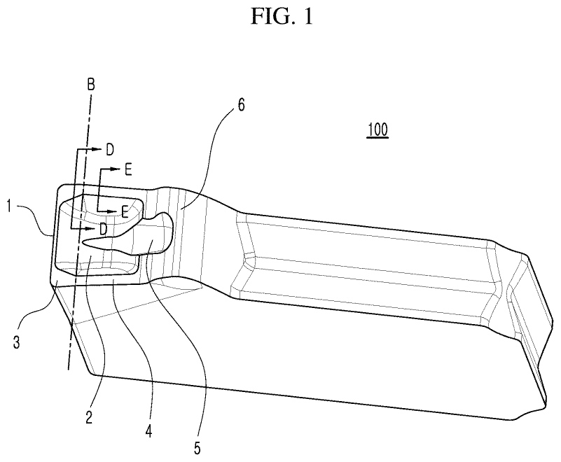

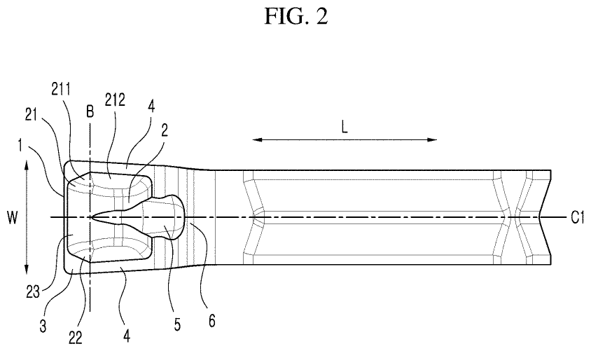

As shown in FIGS. 1 and 2, a cutting insert 100 for groove machining according to an embodiment of the present disclosure includes a front cutting edge 1, a chip breaker groove 2 extending from a rear direction of the front cutting edge 1 in a lengthwise direction L of the cutting insert, land portions 3 formed on both sides of the chip breaker groove 2, and inclined surfaces 4 in continuity with the land portions 3 and extending from the land portions 3 to the rear direction of the cutting insert 100. The land portions 3 and the inclined surfaces 4 are located on both sides of the chip breaker groove 2.

In addition, the cutting insert 100 according to the present disclosure may be mirror symmetric about a lengthwise center line C1 thereof.

For reference, throughout the Detailed Description, referring to FIG. 2 showing the cutting insert 100 in the lengthwise direction L, the left direction corresponds to the “front direction” of the cutting insert 100 and the right direction corresponds to the “rear direction” of the cutting insert 100. Accordingly, the “rear direction” of a certain component means the right side of the component on the basis of FIG. 2.

In particular, in the cutting insert 100 according to the present disclosure, a distance in a transverse direction W between a left wall 21 and a right wall 22 of the chip breaker groove 2 is gradually increased from an entrance 23 of the chip breaker groove 2 to a boundary B between the land portions 3 and the inclined surfaces 4, and then gradually decreased upon passing the boundary B.

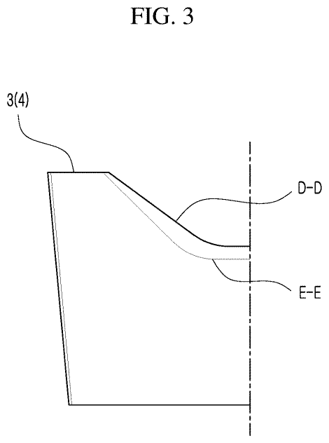

In addition, the left wall 21 includes two-step surfaces 211 and 212 in continuity with each other with reference to the boundary B between the land portions 3 and the inclined surfaces 4, in which a first surface 211 of the two-step surfaces which is located in the front direction of the boundary B may have a smaller slope than that of a second surface 212 located in the rear direction of the boundary B (see FIG. 3). The right wall 22 also has the same configuration. With the configuration described above, it can be seen that the width between the left and right walls 21 and 22 at the same height from the bottom (bottom surface) of the cutting insert 100 is relatively narrower in the front direction of the boundary B.

For reference, FIG. 3 shows a cross-sectional view when viewed in the D-D direction and a cross-sectional view when viewed in the E-E direction of FIG. 1, respectively. An example is chosen for the purpose of illustration, in which the D-D cross-section and the E-E cross-section are located at the same height from the bottom of the cutting insert 100.

As described above, according to the cutting insert 100 according to the present disclosure, the transverse distance between the left wall 21 and the right wall 22 of the chip breaker groove 2, that is, the width is narrower in the front direction of the boundary B than that in the rear direction of the boundary B. Accordingly, during cutting of the workpiece, when the workpiece chips generated from the front cutting edge 1 are discharged to the rear direction of the cutting insert 100, the workpiece chips are first compressed between the left and right walls 21 and 22, that is, compressed at the first surface 211 located in the front direction of the boundary B, and then secondly compressed between the left and right walls 21 and 22, that is, secondly compressed at the second surface 212 located in the rear direction of the boundary B, so that an effect that the chips become smaller than those of the related cutting insert can be obtained.

In addition, as the chip width is reduced, scratches on the cutting surface can be reduced, and the chips can be smoothly discharged from the chip break groove 2.

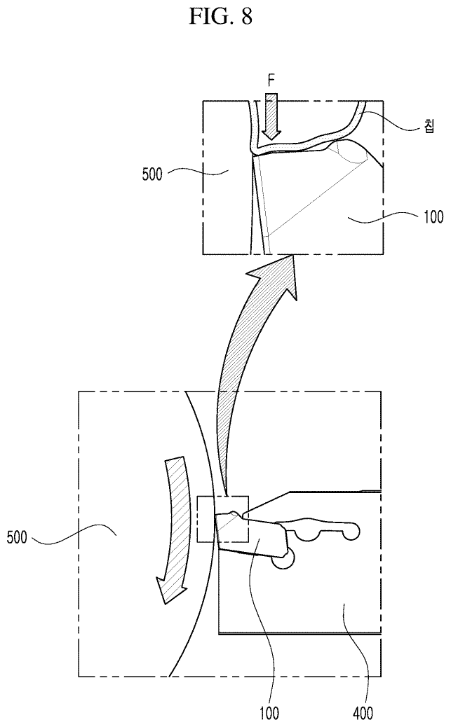

In addition, according to the cutting insert 100 according to the present disclosure, as compared to the related cutting inserts, the chip width can be effectively reduced at the early stage of the chip generation, by the interaction of the large principle force generated when the workpiece is sheared at the front cutting edge 1 and the reaction forces of the left and right walls 21 and 22 of the chip brake groove 2 (for reference, the principle force, the feed force, and the back force act as three force of cutting resistance during the cutting process). That is, referring to FIG. 8, the chip is produced and the shape thereof is determined by the front cutting edge 1 of the cutting insert 100 which generates the shear of the workpiece 500. In the cutting insert 100 according to the present disclosure, as the principal force F in the vertical direction acts at the time of shearing, the chips are first compressed and deformed due to the shape that the width between the left wall 21 and the right wall 22 of the chip breaker groove 2 is narrower in the front direction of the boundary B than in the rear direction of the boundary B.

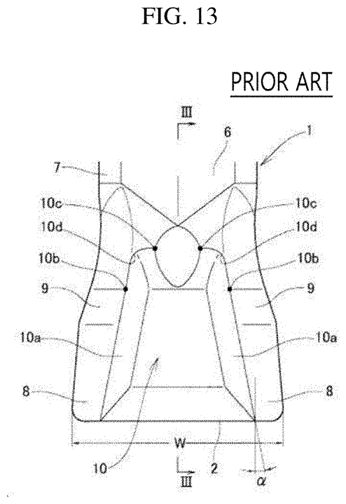

Meanwhile, in the related cutting insert, the chips hit four points (10b and 10d in FIG. 13) in the rear direction of the cutting insert to which the principal force in the vertical direction is hardly applied, according to which the chip shape is deformed and the chip width is reduced. However, in this case, since the principal force in the vertical direction hardly acts on the four points in the rear direction of the cutting insert, the principal force acting vertically downward on the chip is weak and thus has a limit to cause deformation of the chip shape.

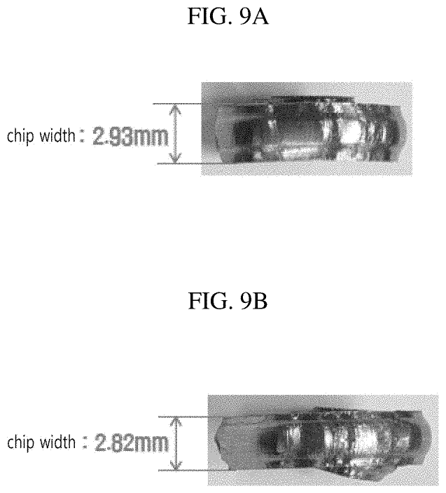

FIG. 9 shows actual photographs of the chips by the cutting insert 100 according to the present disclosure and the chips by the related cutting insert taken under the same processing conditions. The chip width by the cutting insert 100 according to the present disclosure was about 2.82 mm, and the chip width by the related cutting insert was about 2.93 mm, which showed that the chip width was improved in the cutting insert 100 according to the present disclosure.

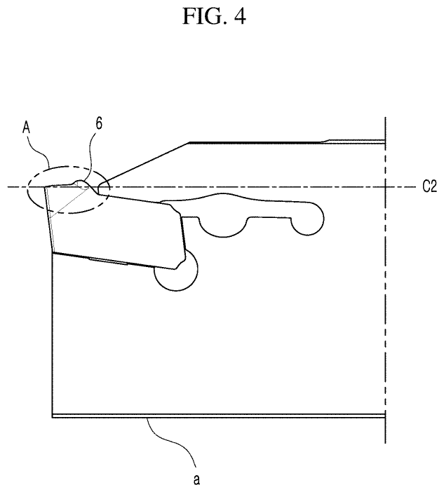

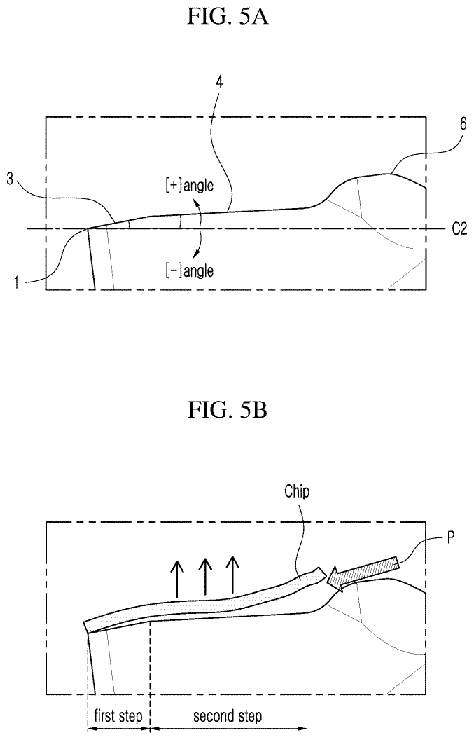

Meanwhile, as shown in FIGS. 4 and 5 showing the cutting insert 100 from the side, when the cutting insert 100 is fastened to a tool holder, the land portions 3 and the inclined surfaces 4 of the cutting insert 100 form positive angles with an imaginary horizontal line C2 parallel to a lower edge a of the tool holder at the time of setting the tool holder on the workpiece. At this time, the angle formed by the land portions 3 is greater than the angle formed by the inclined surfaces 4. That is, the land portions 3 and the inclined surfaces 4 form positive angles in two steps.

Accordingly, as shown in of FIG. 5B, such configuration causes the chips passed the land portions 3 to curl once again, thereby reducing the radius of the chip and lifting the chip upwards. For this reason, there is an effect that the chips are effectively discharged to the outside of the workpiece even in the narrow groove, and also the unnecessary friction of the chips in the chip breaker groove is prevented.

As shown in FIGS. 1, 2 and 5, in the rear direction of the inclined surface 4, a protrusion 6 is formed higher than the inclined surface 4. This protrusion 6 is located in the rear direction of the land portions 3 and the inclined surfaces 4 that form positive angles in two steps, and, for example, acts as a chip breaker when processing a large workpiece, thus serving to cut a chip of a clock spring shape.

In addition, as shown in FIGS. 1, 2 and 6, a protrusion groove 5 is formed in the chip breaker groove 2 and the protrusion 6, in which the protrusion groove 5 is symmetric about the lengthwise center line C1 of the cutting insert, is in continuity with the chip breaker groove 2 without passing through the protrusion 6, and has a greater depth than the chip breaker groove 2.

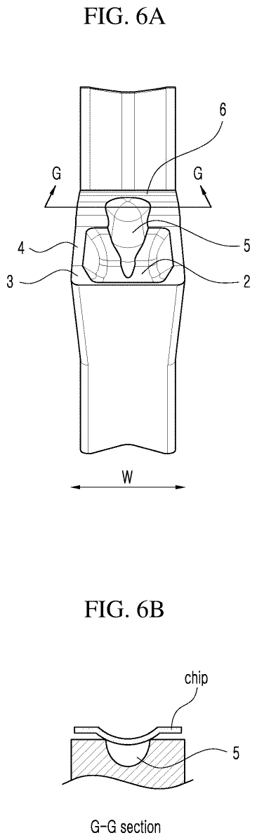

Referring to FIG. 6, the width of the protrusion groove 5 is sized smaller than the chip width brake groove 2. As shown in a cross-sectional view (FIG. 6B) taken along the G-G direction of FIG. 6, the protrusion groove 5 serves as a guide for minimizing the movement in the transverse direction W of the chips formed by the chip brake groove 2 described above, thereby preventing the chips from shaking in the transverse direction when the chips are discharged. Additionally, the protrusion groove 5 may be used as a passage for injecting internal coolant (see P in FIG. 5B). In addition, the protrusion groove 5 may be contacted with the rounded lower portion of the chip deformed at the front cutting edge 1, thereby obtaining an effect that scratches on the machining surface are prevented.

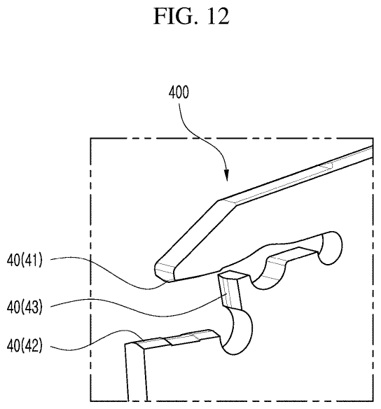

Further, the cutting insert 100 may have grooves such as V-shaped grooves 7 (71, 72, 73) formed on the upper surface, the lower surface, and the rear surface, respectively, which may be engaged with the protrusions such as V-shaped protrusions 40 (41, 42, and 43) of the tool holder shown in FIG. 12 upon fastening to the tool holder (cutting tool), so that the stability of the processing can be maximized. On the contrary, the protrusion may be formed on the cutting insert 100 and the groove may be formed in the tool holder. Meanwhile, for the convenience of production, the grooves may be formed only on the upper and lower surfaces of the cutting insert.

As described above, with the two-step configurations on both sides of the chip breaker groove 2, the configuration of the land portions 3 and the inclined surfaces 4 forming positive angles in two steps, the protrusion 6 in the rear direction, and the protrusion groove 5, the cutting insert 100 for groove machining according to the present disclosure is capable of providing stable chip processing performance in groove machining of not only small workpieces, but also large workpieces with which chip processing is not easy. Further, compared to the related cutting insert for groove machining, the cutting insert 100 for groove machining according to the present disclosure is capable of effectively reducing the chip width for various workpieces and under various processing conditions, thus providing excellent chip discharge effect.

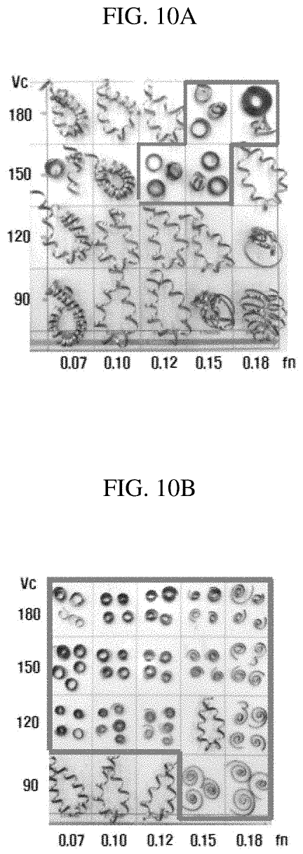

FIGS. 10A and 10B show photographs showing result of processing chips with the related cutting insert and the cutting insert according to the present disclosure. FIG. 10A corresponds to the result by the related cutting insert, and FIG. 10B corresponds to the result by the cutting insert of the present disclosure.

The test conditions included the cutting speed Vc of 90 to 180 m/min, the feed rate fn of 0.07 to 0.18 mm/rev, and the workpiece of material SCM440 and with a diameter of 100 mm. As can be seen from the chip map results, it can be seen that the better curling of the chips and subsequently reduced chip width were obtained when cutting was performed with the cutting insert of the present disclosure than with the related cutting insert.

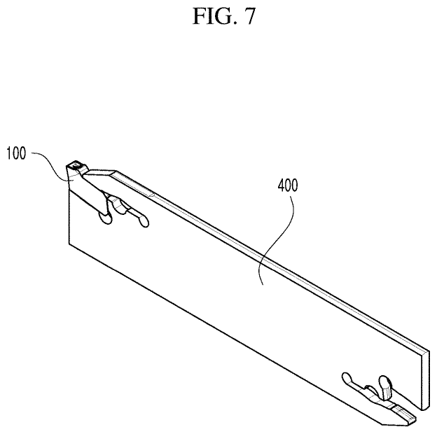

FIG. 7 shows the cutting insert 100 according to the present disclosure mounted in the cutting tool 400.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A cutting insert for groove machining, comprising:
a front cutting edge;
a chip breaker groove extending from a rear direction of the front cutting edge in a lengthwise direction of the cutting insert;
land portions formed on both sides of the chip breaker groove; and
inclined surfaces in continuity with the land portions and extending from the land portions to a rear direction of the cutting insert,
wherein a distance in a transverse direction between left and right walls of the chip breaker groove gradually increases from an entrance of the chip breaker groove toward a boundary between the land portions and the inclined surfaces, and then gradually decreases upon passing the boundary, and
the cutting insert is symmetrical about a lengthwise center line thereof.

2. The cutting insert according to claim 1, wherein the left wall comprises two-step surfaces in continuity with each other at the boundary, in which a first surface of the two-step surfaces located in a front direction of the boundary has a smaller slope than a slope of a second surface located in a rear direction of the boundary.

3. The cutting insert according to claim 1, comprising a protrusion formed in a rear direction of the inclined surfaces and higher than the inclined surfaces.

4. The cutting insert according to claim 3, comprising a protrusion groove formed in the chip breaker groove and the protrusion, wherein the protrusion groove is symmetric about the lengthwise center line, is in continuity with the chip breaker groove without passing through the protrusion, and has a greater depth than the chip breaker groove.

5. The cutting insert according to claim 1, wherein, when the cutting insert is fastened to a cutting tool, the land portions and the inclined surfaces form positive angles with a virtual horizontal line parallel to a lower edge of the cutting tool.

6. The cutting insert according to claim 5, wherein an angle formed by the land portions is greater than an angle formed by the inclined surfaces.

7. The cutting insert according to claim 1, wherein the cutting insert includes a groove or a protrusion formed on an upper surface, a lower surface, and a rear surface to be engaged with a corresponding protrusion or groove formed on the cutting tool for fastening.

8. The cutting tool equipped with the cutting insert according to claim 1.

9. The cutting tool equipped with the cutting insert according to claim 2.

10. The cutting tool equipped with the cutting insert according to claim 3.

11. The cutting tool equipped with the cutting insert according to claim 4.

12. The cutting tool equipped with the cutting insert according to claim 5.

13. The cutting tool equipped with the cutting insert according to claim 6.

14. The cutting tool equipped with the cutting insert according to claim 7.
